(19) United States
(12) Patent Application Publication
(10) Pub. No.: US 2019/0047701 A1
(43) Pub. Date: Feb. 14, 2019

(54) SYSTEMS AND METHODS FOR FACILITATING IN-FLIGHT RECHARGING OF UNMANNED AERIAL VEHICLES

(71) Applicant: Walmart Apollo, LLC, Bentonville, AR (US)

(72) Inventors: David C. Winkle, Bella Vista, AR (US); Donald R. High, Noel, MO (US); John J. O'Brien, Farmington, AR (US); Todd D. Mattingly, Bentonville, AR (US)

(21) Appl. No.: 16/055,508

(22) Filed: Aug. 6, 2018

Related U.S. Application Data
(60) Provisional application No. 62/542,965, filed on Aug. 9, 2017.

(51) Int. Cl. B64C 39/02; H02J 7/00

(52) U.S. Cl. CPC B64C 39/024; H02J 7/0054; B64C 2201/145; B64C 2201/066; B64C 2201/128; B64C 2201/042

(57) ABSTRACT

In some embodiments, methods and systems are provided that provide for the recharging of UAVs having a low battery while the UAVs are in-flight. The system monitors battery status of the UAVs when the UAVs are performing a flight mission, detects when the battery power of a UAV is depleted such that a battery recharge is needed, determines which battery charging source to deploy to recharge the UAV while the UAV is airborne, and facilitates the coupling of the UAV and the charging source such that the battery of the UAV is recharged, which enables the UAV to continue its flight mission while being coupled to the charging source.

### CROSS-REFERENCE TO RELATED APPLICATION

This application claims the benefit of U.S. Provisional Application No. 62/542,965, filed Aug. 9, 2017, which is incorporated herein by reference in its entirety.

### TECHNICAL FIELD

This disclosure relates generally to transporting products via unmanned aerial vehicles and, in particular, to in-flight recharging of unmanned aerial vehicles.

### BACKGROUND

Product delivery using unmanned aerial vehicles (UAVs) is becoming a popular idea. The UAVs have limited flight range, since they are typically battery-powered. Some UAV-based delivery systems contemplate utilizing ground-based stationary (e.g., installed on rooftops of buildings, cellular towers, and other secure facilities) or mobile (e.g., vehicle-mounted) recharging stations, where the UAVs can land and recharge while traveling along their delivery routes. Since UAV-based delivery is becoming increasingly popular, and since the delivery routes of UAV's constantly vary due to the large numbers of customers in different locations that order products to be delivered by drone, such UAV-based delivery systems increasingly depend on building and installing more charging stations for UAVs and/or manipulating movement of mobile ground-based recharging stations, which significantly increases the costs of such systems.

### BRIEF DESCRIPTION OF THE DRAWINGS

Disclosed herein are embodiments of systems, apparatuses, and methods for facilitating in-air recharging of unmanned aerial vehicles. This description includes drawings, wherein:

FIG. 1 is a diagram of a system for facilitating in-air recharging of unmanned aerial vehicles in accordance with some embodiments;

FIG. 2 is a functional diagram of an exemplary computing device usable with the system of FIG. 1 in accordance with some embodiments;

FIG. 3 comprises a block diagram of an unmanned aerial vehicle as configured in accordance with some embodiments; and

FIG. 4 is a flow chart diagram of a process of facilitating in-air recharging of unmanned aerial vehicles in accordance with some embodiments.

Elements in the figures are illustrated for simplicity and clarity and have not been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Generally, the systems, devices, and methods described herein relate to facilitating the recharging of UAVs having a low battery while the UAVs are in-flight (e.g., on a flight mission from a deployment station to a delivery destination and vice versa, from one delivery destination to another delivery destination, etc.) The system monitors battery status of the UAVs in real time when the UAV is performing a flight mission, detects when the battery power of a UAV is depleted such that a battery recharge is needed, determines which battery charging source to deploy to recharge the UAV while the UAV is airborne, and facilitates the coupling of the UAV and the charging source such that the battery of the UAV is recharged, which enables the UAV to complete its current flight mission (and any additional flight missions, if necessary).

In some embodiments, a system for facilitating in-air recharging of unmanned aerial vehicles comprises: at least one UAV configured to perform a flight mission including taking off from a deployment station, transporting at least one product to at least one delivery destination, and returning to the deployment station, as well as a computing device including a processor-based control circuit and configured for communication with the at least one UAV over a network. The computing device is configured to: receive, from the at least one UAV, at least one sensor input associated with a status of the at least one UAV during the flight mission; determine, based on an analysis by the computing device of the at least one sensor input received from the at least one UAV, that the at least one UAV does not have sufficient battery power to complete the flight mission; identify, after the determination by the computing device that the at least one UAV does not have sufficient battery power to complete the flight mission, a charging source having available power sufficient to recharge the battery power of the at least one UAV such that the at least one UAV is able to complete the flight mission; and transmit a guiding signal from the computing device to the UAV over the network, the guiding signal being configured to guide the UAV toward an in-air charging location, where the charging source is permitted to couple to the UAV in order to recharge the battery power of the UAV. The charging source and the UAV remain coupled during travel of the UAV along at least a portion of the flight mission between the in-air charging location and the at least one delivery destination in order to enable the UAV to continue travelling along the flight mission while being coupled to and recharged by the charging source.

In another embodiment, a method of facilitating in-air recharging of UAVs comprises: providing at least one UAV configured to perform a flight mission including taking off from a deployment station, transporting at least one product to at least one delivery destination, and returning to the deployment station; providing a computing device including a processor-based control circuit and configured for communication with the at least one UAV over a network; receiving, at the computing device and from the at least one UAV, at least one sensor input associated with a status of the at least one UAV during the flight mission; determining, by the computing device and based on an analysis by the computing device of the at least one sensor input received from the at least one UAV, that the at least one UAV does not have sufficient battery power to complete the flight mission; identifying, by the computing device and after the determination by the computing device that the at least one UAV does not have sufficient battery power to complete the flight mission, a charging source having available power sufficient to recharge the battery power of the at least one UAV such that the at least one UAV is able to complete the flight mission; transmitting a guiding signal from the computing device to the UAV over the network, the guiding signal being configured to guide the UAV toward an in-air charging location; permitting the charging source to couple to the UAV in order to recharge the battery power of the UAV; and after the charging source couples to the UAV, permitting travel of the UAV, while being coupled to the charging source, along at least a portion of the flight mission between the in-air charging location and the at least one delivery destination in order to enable the UAV to continue travelling along the flight mission while being coupled to and recharged by the charging source.

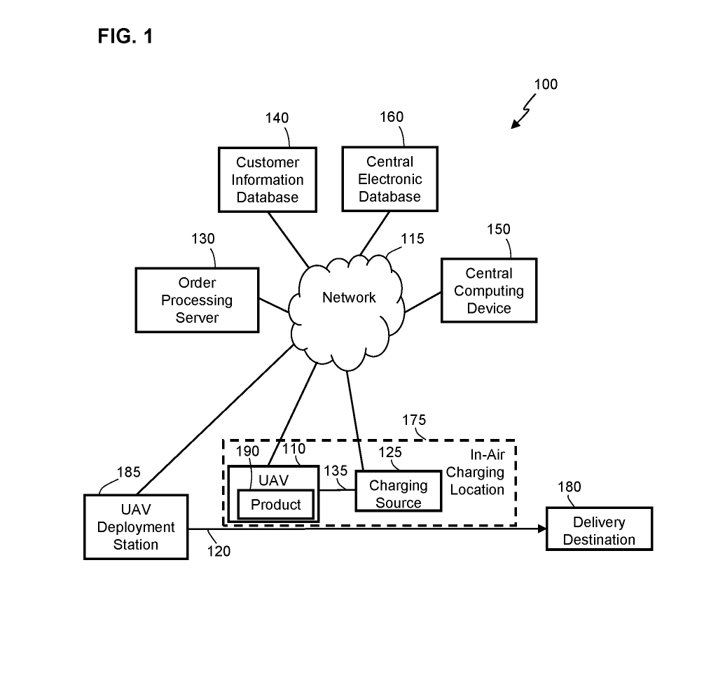

FIG. 1 shows an embodiment of a system 100 for facilitating in-air recharging of UAVs 110. It will be understood that the details of this example are intended to serve in an illustrative capacity and are not necessarily intended to suggest any limitations in regards to the present teachings. In some aspects, the exemplary UAV 110 of FIG. 1 is configured to transport one or more products 190 from one or more UAV deployment stations 185 to one or more delivery destinations 180 via one or more flight routes 120. In other aspects, the UAV 110 is configured to fly along the flight route 120 from a UAV deployment station 185 to a product pick up location. In yet other aspects, the UAV 110 is configured to fly along the flight route 120 from a delivery destination 180 back to the UAV deployment station 185.

A customer may be an individual or business entity. A delivery destination 180 may be a home, work place, or another location designated by the customer when placing the order or scheduling a product return pick-up. Exemplary products 190 that may be ordered by the customer via the system 100 may include, but are not limited to, general-purpose consumer goods (retail products and goods not for sale) and consumable products (e.g., food items, medications, or the like). A UAV deployment station 185 can be mobile (e.g., vehicle-mounted) or stationary (e.g., installed at a facility of a retailer). A retailer may be any entity operating as a brick-and-mortar physical location and/or a website accessible, for example, via an intranet, internet, or another network, by way of which products 190 may be ordered by a consumer for delivery via a UAV 110.

The exemplary system 100 depicted in FIG. 1 includes an order processing server 130 configured to process a purchase order by a customer for one or more products 190. It will be appreciated that the order processing server 130 is an optional component of the system 100, and that some embodiments of the system 100 are implemented without incorporating the order processing server 130. The order processing server 130 may be implemented as one server at one location, or as multiple interconnected servers stored at multiple locations operated by the retailer, or for the retailer. As described in more detail below, the order processing server 130 may communicate with one or more electronic devices of system 100 via a network 115. The network 115 may be a wide-area network (WAN), a local area network (LAN), a personal area network (PAN), a wireless local area network (WLAN), Wi-Fi, Zigbee, Bluetooth, or any other internet or intranet network, or combinations of such networks. Generally, communication between various electronic devices of system 100 may take place over hard-wired, cellular, Wi-Fi or Bluetooth networked components or the like. In some embodiments, one or more electronic devices of system 100 may include cloud-based features, such as cloud-based memory storage.

In the embodiment of FIG. 1, the order processing server 130 communicates with a customer information database 140. In some embodiments, the customer information database 140 may be configured to store information associated with customers of the retailer who order products 190 from the retailer. In some embodiments, the customer information database 140 may store electronic information including but not limited to: personal information of the customers, including payment method information, billing address, previous delivery addresses, phone number, product order history, pending order status, product order options, as well as product delivery options (e.g., delivery by UAV) of the customer. The customer information database 140 may be stored, for example, on non-volatile storage media (e.g., a hard drive, flash drive, or removable optical disk) internal or external to the order processing server 130, or internal or external to computing devices separate and distinct from the order processing server 130. It will be appreciated that the customer information database 140 may likewise be cloud-based.

In the embodiment of FIG. 1, the order processing server 130 is in communication with a central electronic database 160 configured to store information associated with the inventory of products 190 made available by the retailer to the customer, as well as information associated with the UAVs 110 being deployed to deliver products 190 to the delivery destinations 180 specified by the customers. In some aspects, the central electronic database 160 stores information including but not limited to: information associated with the products 190 being transported by the UAV 110; inventory (e.g., on-hand, sold, replenishment, etc.) information associated with the products 190; information associated with predetermined flight routes 120 of the UAV 110; UAV status input information detected by one or more sensors of the UAV 110 during flight along the flight route 120; information indicating the charging sources 125 available for recharging the UAV 110 during the flight of the UAV 110 along the flight route 120; coordinates of the charging sources 125; and charging power capacity of each of the charging sources 125. In some embodiments, UAV status input information may include but is not limited to: battery status of the UAV 110, predicted flight range of the UAV 110 until all battery power is depleted, flight status/mission status of the unmanned aerial vehicle; and global positioning system (GPS) coordinates of the UAV 110.

The central electronic database 160 may be stored, for example, on non-volatile storage media (e.g., a hard drive, flash drive, or removable optical disk) internal or external to the order processing server 130, or internal or external to computing devices separate and distinct from the order processing server 130. The central electronic database 160 may likewise be cloud-based. While the customer information database 140 and the central electronic database 160 are shown in FIG. 1 as two separate databases, it will be appreciated that the customer information database 140 and the central electronic database 160 can be incorporated into one database.

With reference to FIG. 1, the central computing device 150 may be a stationary or portable electronic device, for example, a desktop computer, a laptop computer, a tablet, a mobile phone, or any other electronic device including a processor-based control circuit (i.e., control unit). In this specification, the term “central computing device” will be understood to refer to a computing device owned by the retailer or any computing device owned and/or operated by an entity (e.g., delivery service) having an obligation to deliver products 190 for the retailer. The central computing device 150 of FIG. 1 is configured for data entry and processing as well as for communication with other devices of system 100 via the network 115. In some embodiments, as will be described below, the central computing device 150 is configured to access the central electronic database 160 and/or customer information database 140 via the network 115 to facilitate delivery of products 190 via UAVs 110 along flight routes 120 to delivery destinations 180, and to facilitate in-flight recharging of UAVs 110 when the UAVs 110 are determined by the central computing device 150 to be unable to complete their flight mission from/back to the UAV deployment station 185 due to insufficient battery power.

In the system 100 shown in FIG. 1, the central computing device 150 is in two-way communication with the UAV 110 via the network 115. In some aspects, the central computing device 150 is configured to transmit at least one signal to the UAV 110 to cause the UAV 110 to fly along a flight route 120 determined by the central computing device 150 while transporting products 190 from the UAV deployment station 185 to the intended delivery destination 180 (e.g., to drop off a product 190 or to pick up a product 190), or while returning from the delivery destination 180 to the UAV deployment station 185 (e.g., after dropping off a product 190 or after picking up a product 190). In other aspects, after a customer places an on order for one or more products 190 and specifies a delivery destination 180 for the products 190 via the order processing server 130, prior to and/or after the commencement of a delivery attempt of the products 190 ordered by the customer via a UAV 110 to the delivery destination 180, the central computing device 150 is configured to obtain GPS coordinates associated with the delivery destination 180 selected by the customer and GPS coordinates associated with the UAV deployment station 185 of the retailer (which houses the UAV 110 that will deliver the products 190), and to determine a flight route 120 for the UAV 110 in order to deliver the customer-ordered products 190 from the UAV deployment station 185 to the delivery destination 180.

In some embodiments, the central computing device 150 is configured to receive at least one sensor input from the UAV 110 during the flight mission of the UAV 110 and to determine, based on an analysis of the received sensor input by a processor of the control circuit 210 of the central computing device 150, that the UAV 110 does not have sufficient battery power to complete its flight mission along the flight route 120 generated by the central computing device 150, the central computing device 150 is configured to identify a charging source 125 having available power sufficient to recharge the battery power of the UAV 110 such that the UAV is able to complete its flight mission to/from the delivery destination 180, and to transmit a guiding signal over the network 115 in order to guide the UAV 110 toward an in-air charging location, where the charging source 125 is permitted to couple to the UAV 110 and recharge the battery power of the UAV 110. In addition, in some aspects, after receiving one or more sensor inputs detected by the UAV 110 while the UAV 110 is in flight along the flight route 120, the control circuit 210 of the central computing device 150 is programmed to analyze one or more of the received status inputs in order to determine a suitable charging source 125 to which to assign the task of recharging the UAV 110 and a suitable in-flight charging location 175 where the UAV 110 and the charging source 125 are to couple to each other for recharging the UAV 110.

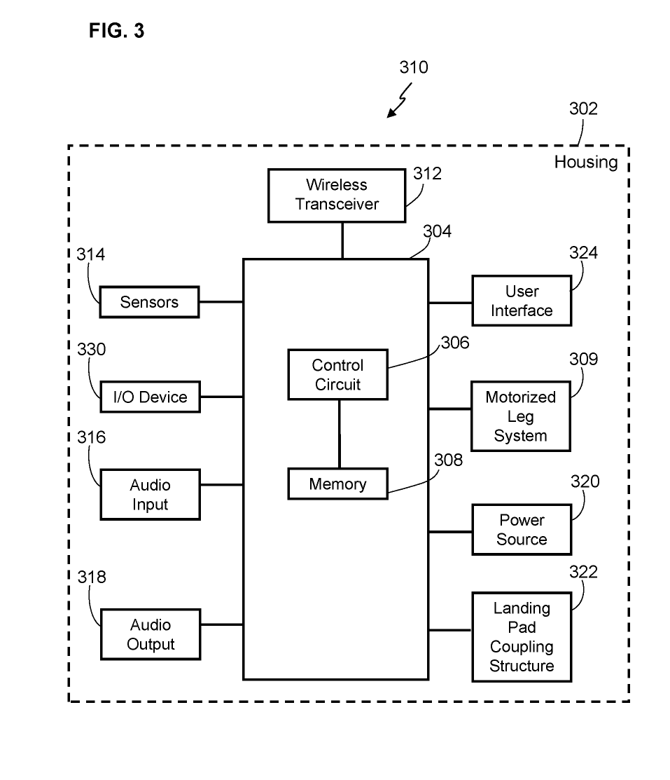

The UAV 110, which will be discussed in more detail below with reference to FIG. 3, is generally an unmanned aerial vehicle configured to autonomously traverse one or more intended environments in accordance with one or more flight routes 120 determined by the central computing device 150, and typically without the intervention of a human or a remote computing device, while retaining the products 190 therein and delivering the products 190 to the delivery destination 180. In some instances, however, a remote operator or a remote computer (e.g., central computing device 150) may temporarily or permanently take over operation of the UAV 110 using feedback information (e.g., audio and/or video content, sensor information, etc.) communicated from the UAV 110 to the remote operator or computer via the network 115, or another similar distributed network. While only one UAV 110 is shown in FIG. 1 for ease of illustration, it will be appreciated that in some embodiments, the central computing device 150 may communicate with, and/or provide flight route instructions to more than one (e.g., 5, 10, 20, 50, 100, 1000, or more) UAVs 110 simultaneously to guide the UAVs 110 to transport products 190 to their respective delivery destinations 180 and/or to facilitate landings/take-offs of the UAVs 110.

In some embodiments, as will be discussed in more detail below, the UAV 110 is equipped with one or more sensors configured to detect and transmit (e.g., internally to the UAV 110 and/or over the network 115) at least one status input associated with the UAV 110 during flight along the flight route 120. In addition, in some configurations, the UAV 110 includes a processor-based control circuit configured to determine, based on an analysis of the status input, that the remaining battery power of the UAV 110 is not sufficient to enable the UAV 110 to complete its current flight mission from the UAV deployment station 185 to the delivery destination 180, as well as to transmit a signal including electronic data (e.g., an alert) indicative of this determination over the network 115 to the central computing device 150.

With reference to FIG. 1, the charging source 125 can include but is not limited to: one or more unmanned aerial vehicles, autonomous and/or manned ground vehicles (e.g., mothership), manned aerial vehicles, mobile relay stations, power lines, and combinations thereof. The charging source 125 and the UAV 110 are shown as being coupled via a connection 135 at an in-air charging location 175 in FIG. 1. It will be appreciated that the connection 135 may be a physical connection (i.e., one that results in physical contact) between the UAV 110 and the charging source 125, or a signal-based connection (i.e., one that does not require physical contact) between the UAV 110 and the charging source 125.

For example, in some embodiments, the charging source 125 is configured to recharge the UAV 110 via physical coupling (via one or more plug-in connectors, magnetic cable, battery swap apparatus, etc.) to the UAV 110. In other embodiments, the charging source 125 is configured to recharge the UAV 110 via remote coupling (via RF induction, photocell light induction, laser induction, etc.) to the UAV 110. In certain embodiments, the charging source 125 is configured to couple to the UAV 110 via the connection 135 at the in-air charging location 175, and to remain coupled to the UAV 110 during travel of the UAV 110 along at least a portion of the flight mission of the UAV 110 between the in-air charging location 175 and the delivery destination 180 in order to enable the UAV 110 to continue travelling on its mission along the flight route 120 while being continuously coupled to and recharged by the charging source 125. In some embodiments, as will be discussed in more detail below, the charging source 125 is configured to directly power the UAV 110 without recharging the battery power of the UAV 110, thereby enabling the UAV 110 to continue its mission along the flight route 120 while being powered by the charging source 125.

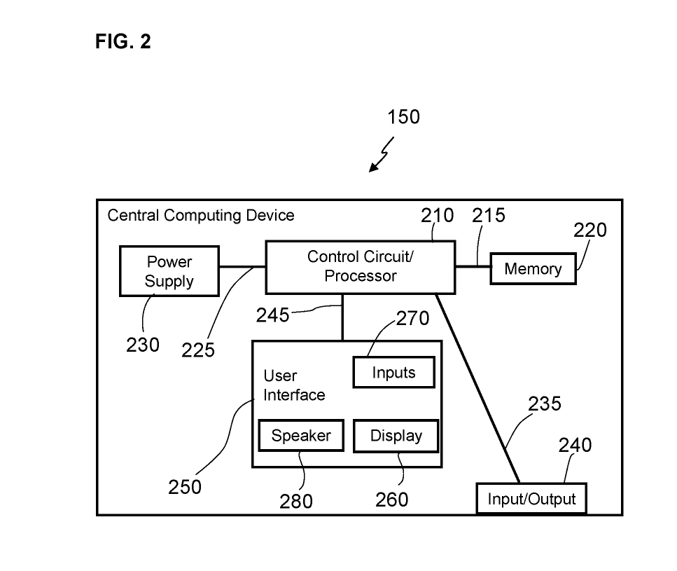

With reference to FIG. 2, an exemplary central computing device 150 configured for use with the systems and methods described herein may include a control unit or control circuit 210 including a processor (for example, a microprocessor or a microcontroller) electrically coupled via a connection 215 to a memory 220 and via a connection 225 to a power supply 230. The control circuit 210 can comprise a fixed-purpose hard-wired platform or can comprise a partially or wholly programmable platform, such as a microcontroller, an application specification integrated circuit, a field programmable gate array, and so on. These architectural options are well known and understood in the art and require no further description here.

The control circuit 210 of the central computing device 150 can be configured (for example, by using corresponding programming stored in the memory 220 as will be well understood by those skilled in the art) to carry out one or more of the steps, actions, and/or functions described herein. In some embodiments, the memory 220 may be integral to the processor-based control circuit 210 or can be physically discrete (in whole or in part) from the control circuit 210 and is configured non-transitorily store the computer instructions that, when executed by the control circuit 210, cause the control circuit 210 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM)) as well as volatile memory (such as an erasable programmable read-only memory (EPROM))). Thus, the memory and/or the control circuit may be referred to as a non-transitory medium or non-transitory computer readable medium.

The control circuit 210 of the central computing device 150 is also electrically coupled via a connection 235 to an input/output 240 that can receive signals from the UAV 110 and/or order processing server 130 and/or customer information database 140 and/or central electronic database 160. For example, in some approaches, the central computing device 150 receives sensor data representing at least one status input associated with the UAV 110 during flight of the UAV 110 along the flight route 120 (e.g., a low battery power alert from the UAV 110 indicating that a re-charge of the UAV 110 is required) and data relating to an order for a product 190 placed by the customer, location data (e.g., GPS coordinates) associated with the delivery destination 180 selected by the customer, or from any other source that can communicate with the central computing device 150 via a wired or wireless connection.

The input/output 240 of the central computing device 150 can also send signals to the UAV 110 (e.g., a control signal indicating a flight route 120 determined by the central computing device 150 for the UAV 110 in order to deliver the product 190 from the UAV deployment station 185 to the delivery destination 180). The input/output 240 of the central computing device 150 can also send signals to the order processing server 130 (e.g., notification indicating that the UAV 110 successfully delivered the product 190 to the delivery destination 180). In some aspects, the central computing device 150 is configured to transmit, via the input/output 240 and over the network 115, a guiding signal to the UAV 110 in order to guide the UAV 110 toward an in-air charging location 175 determined by the central computing device 150, where the charging source 125 is permitted to couple to the UAV 110 in order to recharge the battery power of the UAV 110. In other aspects, the central computing device 150 is configured to transmit, via the input/output 240 and over the network 115, a guiding signal to the charging source 125 selected by the central computing device 150 for recharging the UAV 110 in order to guide the charging source 125 toward the in-air charging location 175 determined by the central computing device 150, where the charging source 125 is permitted to couple to the UAV 110 in order to recharge the battery power of the UAV 110. In some aspects, the guiding signal transmitted from the central computing device 150 to the charging source 125 can include electronic data indicating how much power the charging source 125 is to transfer to the UAV 110.

In the embodiment of FIG. 2, the processor-based control circuit 210 of the central computing device 150 is electrically coupled via a connection 245 to a user interface 250, which may include a visual display or display screen 260 (e.g., LED screen) and/or button input 270 that provide the user interface 250 with the ability to permit an operator of the central computing device 150 to manually control the central computing device 150 by inputting commands via touch-screen and/or button operation and/or voice commands to, for example, to transmit a control signal to the UAV 110 in order to provide the UAV 110 with the flight route 120 from the UAV deployment station 185 to the delivery destination 180, or to transmit a guiding signal to the UAV 110 to guide the UAV 110 toward an in-air charging location 175 where the UAV 110 and the charging source 125 can couple to enable the charging source 125 to charge the UAV 110. It will be appreciated that the performance of such functions by the processor-based control circuit 210 of the central computing device 150 is not dependent on a human operator, and that the control circuit 210 may be programmed to perform such functions without a human operator.

In some aspects, the display screen 260 of the central computing device 150 is configured to display various graphical interface-based menus, options, and/or alerts that may be transmitted to the central computing device 150 and displayed on the display screen 260 in connection with various aspects of the delivery of the products 190 ordered by the customers by the UAVs 110, various aspects of monitoring the UAVs 110 while they are in-flight, and various aspects of controlling the recharging of the UAV 110 to enable the UAVs 110 to successfully complete their flight missions. The inputs 270 of the central computing device 150 may be configured to permit an operator to navigate through the on-screen menus on the central computing device 150 and change and/or update the flight route 120 of the UAV 110 toward or away from the delivery destination 180 and/or to guide a UAV 110 having low/insufficient battery power toward an in-air charging location 175 determined by the central computing device 150, and/or to guide the charging source 125 toward the in-air charging location 175, and/or to guide the UAV 110 and the charging source 125, after they are coupled to enable the recharging of the UAV 110, toward or away from the delivery destination 180. It will be appreciated that the display screen 260 may be configured as both a display screen and an input 270 (e.g., a touch-screen that permits an operator to press on the display screen 260 to enter text and/or execute commands.)

In some embodiments, after an order for one or more products 190 is placed by a customer via the order processing server 130, and prior to commencement of the delivery attempt of one or more products 190 via the UAV 110 to the delivery destination 180 designated by the customer, the control circuit 210 of the central computing device 150 is programmed to obtain the GPS coordinates of the delivery destination 180 where the product 190 is to be delivered by the UAV 110. For example, in embodiments, where the customer requested delivery of a product 190 or products 190 to a delivery destination 180 associated with a specific geographic location (e.g., home address, work address, etc.), the control circuit 210 of the central computing device 150 obtains the GPS coordinates associated with the delivery destination 180, for example, from the customer information database 140, or from another source configured to provide GPS coordinates associated with a given physical address.

In some embodiments, the control circuit 210 of the central computing device 150 is configured to analyze the GPS coordinates of both the UAV deployment station 185 and the delivery destination 180, and to determine and generate a flight route 120 for the UAV 110. In one aspect, the flight route 120 determined by the central computing device 150 is based on a starting location of the UAV 110 (e.g., a UAV deployment station 185) and the intended destination of the UAV 110 (e.g., delivery destination 180 and/or product pick up destination). In some aspects, the central computing device 150 is configured to calculate multiple possible flight routes 120 for the UAV 110, and then select a flight route 120 determined by the central computing device 150 to provide an optimal flight time and/or conditions while flying along the original flight route 120. In some embodiments, after the control circuit 210 of the central computing device 150 determines and generates a flight route 120 for the UAV 110, the central computing device 150 transmits, via the output 240 and over the network 115, a signal including the flight route 120 to the UAV 110 assigned to deliver one or more products 190 from the UAV deployment station 185 to the delivery destination 180.

In some embodiments, the central computing device 150 is capable of integrating 2D and 3D maps of the navigable space of the UAV 110 along the flight route 120 determined by the central computing device 150, complete with topography data comprising: no fly zones along the flight route 120 and on-ground buildings, hills, bodies of water, power lines, roads, vehicles, people, and/or known safe landing points for the UAV 110 along the flight route 120. After the central computing device 150 maps all in-air and on-ground objects along the flight route 120 of the UAV 110 to specific locations using algorithms, measurements, and GPS geo-location, for example, grids may be applied sectioning off the maps into access ways and blocked sections, enabling the UAV 110 to use such grids for navigation and recognition. The grids may be applied to 2D horizontal maps along with 3D models. Such grids may start at a higher unit level and then can be broken down into smaller units of measure by the central computing device 150 when needed to provide more accuracy.

In some aspects, while the UAV 110 is in flight from the UAV deployment station 185 toward the delivery destination 180 along the flight route 120 determined by the central computing device 150, the central computing device 150 is configured to continuously or at regular intervals (e.g., 30 seconds, 1 minute, 5 minutes, 15 minutes, etc.) receive from the UAV 110 one or more sensor inputs such as battery status of the UAV 110 and/or predicted flight range of the UAV 110 until all battery power is depleted. Such sensor inputs may be received by the central computing device 150 directly or indirectly (e.g., via the central electronic database 160) from the UAV 110 over the network 115. In certain aspects, the central electronic database 160 also stores electronic data indicating the charging sources 125 available to recharge a given UAV 110 flying along the flight route 120, and the central computing device is configured to obtain such data, from the central electronic database 160 over the network, and analyze the electronic data obtained from the central electronic database in order to select, from the charging sources 125 indicated in the central electronic database 160, a charging source 125 having both the available power sufficient to recharge battery power of the UAV 110 such that the UAV 110 is able to complete its flight mission, and a recharging device complementary to the UAV 110.

In some embodiments, the central computing device 150 is configured to guide the UAV 110 and the charging source 125 towards the in-air charging location 175 to facilitate the coupling of the UAV and the charging source 125 at the in-air charging location 175. To that end, in some aspects, the central computing device 150 is configured to determine GPS coordinates of the in-air charging location 175, and to indicate, in the guiding signal transmitted by the central computing device 150 to the UAV 110 and/or the charging source 125, the GPS coordinates of the determined in-air charging location 175.

In some embodiments, the central computing device 150 is configured to guide the UAV 110 and the charging source 125, after they have coupled at the in-air charging location 175 and while they remain coupled, along at least a portion of the flight mission of the UAV 110 between the in-air charging location 175 and the delivery destination 180 in order to enable the UAV 110 to continue travelling along the flight mission route 120 while being continuously coupled to and recharged by the charging source 125. In some aspects, the central computing device 150 is configured to determine a time interval during which the charging source 125 is to be coupled to the UAV 110 at the in-air charging location 175 and/or during travel of the UAV 110 along at least a portion of the flight mission of the UAV 110 between the in-air-charging location 175 and one or more delivery destinations 180 and/or between the in-air charging location 175 and the UAV deployment station 185.

FIG. 3 presents a more detailed exemplary embodiment of the UAV 310 of FIG. 1. In this example, the UAV 310 has a housing 302 that contains (partially or fully) or at least supports and carries a number of components. These components include a control unit 304 comprising a control circuit 306 that, like the control circuit 210 of the central computing device 150, controls the general operations of the UAV 310. The control unit 304 includes a memory 308 coupled to the control circuit 306 for storing data such as operating instructions and/or useful data.

In some embodiments, the control circuit 306 operably couples to a motorized leg system 309. This motorized leg system 309 functions as a locomotion system to permit the UAV 310 to land onto the ground or onto a landing pad at the delivery destination 180 and/or to move laterally at the delivery destination 180 or at a UAV deployment station 185. Various examples of motorized leg systems are known in the art. Further elaboration in these regards is not provided here for the sake of brevity save to note that the control circuit 306 may be configured to control the various operating states of the motorized leg system 309 to thereby control when and how the motorized leg system 309 operates.

In the exemplary embodiment of FIG. 3, the control circuit 306 operably couples to at least one wireless transceiver 312 that is configured as a two-way transceiver and operates according to any known wireless protocol. This wireless transceiver 312 can comprise, for example, a cellular-compatible, Wi-Fi-compatible, and/or Bluetooth-compatible transceiver that can wirelessly communicate with the central computing device 150 via the network 115. These teachings will accommodate using any of a wide variety of wireless technologies as desired and/or as may be appropriate in a given application setting. These teachings will also accommodate employing two or more wireless transceivers 312. So configured, the control circuit 306 of the UAV 310 can provide information (e.g., sensor input) to the central computing device 150 (via the network 115) and can receive information and/or movement (e.g., routing and rerouting) instructions from the central computing device 150.

In some embodiments, the wireless transceiver 312 is configured to receive a signal containing instructions including the flight route 120 and/or instructions for guiding the UAV 110 to an in-air charging location 175 transmitted from the central computing device 150, and that can transmit one or more signals (e.g., including sensor input information detected by one or more sensors of the UAV 110) to the central computing device 150. For example, the control circuit 306 of the UAV 310 can receive control signals from the central computing device 150 via the network 115 containing instructions regarding directional movement of the UAV 310 along a specific, central computing device-determined flight route 120 when, for example: flying from the UAV deployment station 185 to the delivery destination 180 to drop off and/or pick up a product 190, when returning from the delivery destination 180 after dropping off or picking up a product 190 to the UAV deployment station 185, while flying independently or while coupled to a charging source 125 that provides a continuous charge to the battery of the UAV 110 or direct power to the UAV 110 without charging the battery of the UAV 110. In some aspects, the UAV 310 transmits over the network 115 and via the transceiver 312, an alert signal to the central computing device 150 indicating that the UAV 110 is experiencing a low-battery condition that requires an in-flight recharging of the UAV 110 to enable the UAV 110 to complete its flight mission.

In particular, as discussed above, the central computing device 150 can be configured to analyze GPS coordinates of the delivery destination 180 designated by the customer, determine a flight route 120 for the UAV 110 to the delivery destination 180, and transmit to the wireless transceiver 312 of the UAV 110 a first control signal including the flight route 120 over the network 115. The UAV 110, after receipt of the first control signal and/or guiding signal from the central computing device 150 over the network 115 via the wireless transceiver 312, is configured to navigate, based on the route instructions in the control signal and/or guiding signal, to the delivery destination 180 and/or in-air charging location 175.

With reference to FIG. 3, the control circuit 306 of the UAV 310 also couples to one or more on-board sensors 314 of the UAV 310. These teachings will accommodate a wide variety of sensor technologies and form factors. In some embodiments, the on-board sensors 314 can comprise any relevant device that detects and/or transmits at least one status of the UAV 310 during flight of the UAV 110 along the flight route 120. The sensors 314 of the UAV 310 can include but are not limited to: altimeter, velocimeter, thermometer, GPS data, photocell, battery life sensor, video camera, radar, lidar, laser range finder, sonar, electronics status, and communication status.

In some embodiments, the information obtained by the sensors 314 of the UAV 310 is used by the UAV 310 and/or the central computing device 150 in functions including but not limited to: navigation, landing, on-the-ground object detection, potential in-air object detection, distance measurements, topography mapping, in-air charging location 175 determination, and charging source 125 determination. In some aspects, the status input detected and/or transmitted by one or more sensors 314 of the UAV 310 includes but is not limited to GPS coordinates of the UAV 310, marker beacon data along the flight route 120, and way point data along the flight route 120. Such data, when obtained by the central computing device 150 (either directly from the UAV 110 or from the central electronic database 160) enables the control circuit 210 of the central computing device 150 and/or the control circuit 306 of the UAV 310, based on an analysis of at least such location data, to determine a suitable charging source 125 to facilitate the recharging of the UAV 110 and a suitable in-air charging location 175 where the UAV 310 and the charging source 125 can be guided to couple to each other to enable the recharging of the UAV 110 such that the UAV 110 can complete its assigned flight mission.

For example, in some aspects, the sensors 314 include one or more devices that can be used to capture data related to one or more in-air objects (e.g., other UAVs 310, helicopters, birds, rocks, etc.) located within a threshold distance relative to the UAV 310. For example, the UAV 310 includes at least one on-board sensor 314 configured to detect at least one obstacle between the UAV 310 and the delivery destination 180 designated by the customer. Based on the detection of one or more obstacles by such a sensor 314, the UAV 310 is configured to avoid the obstacle(s). In some aspects, the UAV 310 may attempt to avoid detected obstacles, and if unable to avoid, to notify the central computing device 150 of such a condition. In some aspects, using on-board sensors 314 (such as distance measurement units, e.g., laser or other optical-based distance measurement sensors), the UAV 310 detects obstacles in its path, and flies around such obstacles or stops until the obstacle is clear.

In some aspects, the UAV 310 includes sensors 314 configured to recognize environmental elements along the flight route 120 of the UAV 310 toward and/or away from the delivery destination 180. Such sensors 314 can provide information that the control circuit 306 and/or the central computing device 150 can employ to determine a present location, distance, and/or orientation of the UAV 310 relative to one or more in-air objects and/or objects and surfaces at the delivery destination 180 and/or the UAV deployment station 185. These teachings will accommodate any of a variety of distance measurement units including optical units and sound/ultrasound units. A sensor 314 may comprise an altimeter and/or a laser distance sensor device capable of determining a distance to objects in proximity to the sensor 314.

In some aspects, the UAV 310 includes an on-board sensor 314 (e.g., a video camera) configured to detect map reference and/or topography and/or people and/or objects at the delivery destination 180 and/or UAV deployment station 185 and/or in-air charging location 175. For example, in some aspects, a video camera-based sensor 314 on-board the UAV 310 transmits images during the attempted coupling of the UAV 310 and the charging source 125 at the in-air charging location 175 determined by the central computing device 150, facilitating the correct position and/or orientation of the UAV 310 and/or the charging source 125 required for their proper coupling. In some aspects, the sensor 314 of the UAV 310 is configured to transmit (e.g., via internal circuitry and/or via the transceiver 312) still and/or moving images of the landing location at the delivery destination 180 to the control circuit 306 of the UAV 110 and/or the control circuit 210 of the central computing device 150, which allows the control circuit 306 of the UAV 310 and/or the control circuit 210 of the central computing device 150 to determine the correct position and/or orientation of the UAV 310 and/or the charging source 125 required for the proper landing of the UAV 110 alone and/or for the proper landing of the UAV 110 and the charging source 125 when coupled to each other.

In some embodiments, an audio input 316 (such as a microphone) and/or an audio output 318 (such as a speaker) can also operably couple to the control circuit 306 of the UAV 310. So configured, the control circuit 306 can provide for a variety of audible sounds to enable the UAV 310 to communicate with, for example, the central computing device 150, charging source 125, other UAVs, or other in-air or ground-based electronic devices. Such sounds can include any of a variety of tones and/or sirens and/or other non-verbal sounds. Such audible sounds can also include, in lieu of the foregoing or in combination therewith, pre-recorded or synthesized speech.

In the embodiment illustrated in FIG. 3, the UAV 310 includes a power source 320 such as one or more batteries. The power provided by the power source 320 can be made available to whichever components of the UAV 310 require electrical energy. By one approach, the UAV 310 includes a plug or other electrically conductive interface that the control circuit 306 can utilize to permit the UAV 310 to physically connect (e.g., via compatible plugs/adapter, magnetic cables, etc.) and/or remotely couple (via induction signals, etc.) to an external source of energy such as a charging source 125 in order to recharge and/or replace the power source 320. For example, in some embodiments, the power source 320 is configured as a rechargeable battery that can be recharged by the charging source 125 when the charging source 125 and the UAV 110 are coupled via the above-described connection 135. In other embodiments, the power source 320 is configured as one or more replaceable batteries that can be removed and replaced by the charging source 125 when the charging source 125 and UAV 110 are coupled via the connection 135. In some aspects, the power source 320 may be configured as a device that can be recharged by induction (e.g., RF induction, light induction, laser induction, thermal induction, etc.).

These teachings will also accommodate optionally selectively and temporarily coupling the UAV 310 to another structure or electronic device (e.g., charging source 125, landing pad, deployment dock, etc.). In such aspects, the UAV 310 includes a coupling structure 322. By one approach such a coupling structure 322 operably couples to a control circuit 306 to thereby permit the latter to control movement of the UAV 310 (e.g., via hovering and/or via the motorized leg system 309) towards a particular charging source 125 until the coupling structure 322 can engage the charging source 125 to thereby temporarily physically couple the UAV 310 to the charging source 125 and enable the charging source 125 to recharge the UAV 310 and/or to travel along a portion of the delivery route 120 while coupled to the UAV 310.

The exemplary UAV 310 of FIG. 3 also includes a an input/output (I/O) device 330 that is coupled to the control circuit 306. The I/O device 330 allows an external device to couple to the control unit 304. The function and purpose of connecting devices will depend on the application. In some examples, devices connecting to the I/O device 330 may add functionality to the control unit 304, allow the exporting of data from the control unit 304, allow the diagnosing of the UAV 310, and so on.

The exemplary UAV 310 of FIG. 3 also includes a user interface 324 including for example, user inputs and/or user outputs or displays depending on the intended interaction with a user (e.g., a worker of a retailer, UAV delivery service, a customer, etc.). For example, user inputs could include any input device such as buttons, knobs, switches, touch sensitive surfaces or display screens, and so on. Example user outputs include lights, display screens, and so on. The user interface 324 may work together with or separate from any user interface implemented at an optional user interface unit (such as a smart phone or tablet device) usable by the worker.

In some embodiments, the UAV 310 may be controlled by a user in direct proximity to the UAV 310, for example, an operator of the UAV deployment station 185 (e.g., a driver of a moving vehicle), or by a user at any location remote to the location of the UAV 310 (e.g., regional or central hub operator). This is due to the architecture of some embodiments where the central computing device 150 outputs control signals to the UAV 310. These controls signals can originate at any electronic device in communication with the central computing device 150. For example, the signals sent to the UAV 310 may be movement instructions determined by the central computing device 150 and/or initially transmitted by a device of a user to the central computing device 150 and in turn transmitted from the central computing device 150 to the UAV 310.

The control unit 304 of the UAV 310 includes a memory 308 coupled to a control circuit 306 and storing data such as operating instructions and/or other data. The control circuit 306 can comprise a fixed-purpose hard-wired platform or can comprise a partially or wholly programmable platform. These architectural options are well known and understood in the art and require no further description. This control circuit 306 is configured (e.g., by using corresponding programming stored in the memory 308 as will be well understood by those skilled in the art) to carry out one or more of the steps, actions, and/or functions described herein. The memory 308 may be integral to the control circuit 306 or can be physically discrete (in whole or in part) from the control circuit 306 as desired. This memory 308 can also be local with respect to the control circuit 306 (where, for example, both share a common circuit board, chassis, power supply, and/or housing) or can be partially or wholly remote with respect to the control circuit 306. This memory 308 can serve, for example, to non-transitorily store the computer instructions that, when executed by the control circuit 306, cause the control circuit 306 to behave as described herein. It is noted that not all components illustrated in FIG. 3 are included in all embodiments of the UAV 310. That is, some components may be optional depending on the implementation.

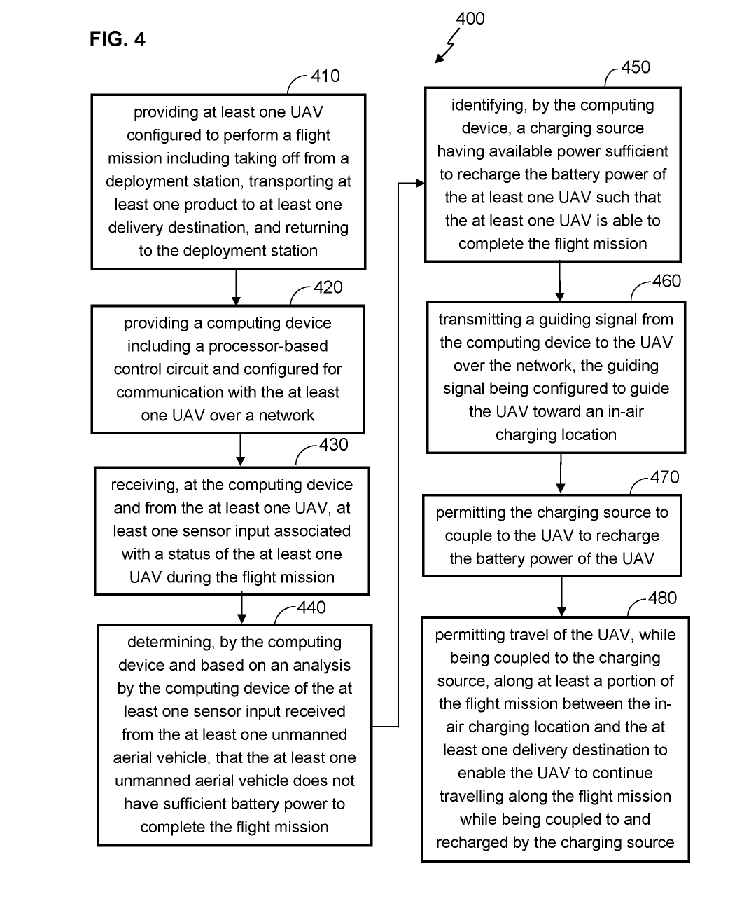

FIG. 4 shows an embodiment of an exemplary method 400 of facilitating in-air recharging of unmanned aerial vehicles. For exemplary purposes, the method 400 is described in the context of the system 100 of FIG. 1, but it is understood that embodiments of the method 400 may be implemented in this or other systems. The embodiment of the method 400 illustrated in FIG. 4 includes providing at least one UAV 110 configured to perform a flight mission including taking off from a deployment station 185, transporting at least one product 190 to at least one delivery destination 180, and returning to the deployment station 185 (step 410). The method 400 further includes providing a computing device 150 including a processor-based control circuit 210 and in communication with the UAV 110 over the network 115 (step 420).

As discussed above, the central computing device 150 is configured to obtain and analyze the relative locations of the UAV deployment station 185 and delivery destination 180 in order to determine a flight route 120 for the UAV 110 from the UAV deployment station 185 to the delivery destination 180. For example, in some embodiments, the central computing device 150 obtains GPS data associated with the delivery destination 180 from the customer information database 140 and GPS data associated with the UAV deployment station 185 from the central electronic database 160. As discussed above, the customer information database 140 and the central electronic database 160 may be implemented as a single database.

As discussed above, while the UAV 310 is in flight along the flight route 120 from the UAV deployment station 185 to the delivery destination 180, the onboard sensors 314 of the UAV 310 monitor various parameters relating to the flight mission of the UAV 310 and the status of the UAV 310. The sensor inputs detected by the onboard sensors 314 of the UAV 310 are transmitted (e.g., via the wireless transceiver 312) to the central computing device 150 and/or central electronic database 160 over the network 115. To that end, the exemplary method 400 includes the step of receiving, at the central computing device 150 and from one or more UAVs 310, at least one sensor input associated with a status of the one or more UAVs 310 during the flight mission (step 430).

While the data detected by the sensors 314 is expected to, in most cases, indicate that the flight mission is going as planned, in certain situations, the sensors 314 indicate that the UAV 310 does not have enough battery power to complete the flight mission assigned to the UAV 310. In the embodiment illustrated in FIG. 4, the method 400 includes determining, via the control circuit 210 of the central computing device 150 and based on an analysis of one or more status inputs received from the UAV 310, that the UAV 310 does not have sufficient battery power to complete the flight mission (step 440). In certain embodiments, such a determination may be made by the UAV 310 instead of the central computing device 150, via the control circuit 306 of the UAV 310 analyzing one or more status inputs detected by the sensors 314, determining that the UAV 310 does not have sufficient battery power to complete the flight mission, and causing the UAV 310 to transmit an alert signal indicative of this determination by the control circuit 306 to the central computing device 150 and/or central electronic database 160 over the network 115.

As discussed above, the central electronic database 160 stores information including but not limited to: information associated with predetermined flight routes 120 of the UAV 110; UAV status input information detected by one or more sensors of the UAV 110 during flight along the flight route 120; information indicating the charging sources 125 available for recharging the UAV 110 during the flight of the UAV 110 along the flight route 120; coordinates of the charging sources 125; and charging power capacity of each of the charging sources 125. In some embodiments, after the control circuit 210 of the central computing device 150 determines that the UAV 310 does not have sufficient battery power to complete the flight mission assigned to the UAV 310, the control circuit 210 is programmed to determine a suitable charging source 125 to provide additional charge to the UAV 310.

To that end, the method 400 further includes identifying, via the control circuit 210 of the central computing device 150 a charging source having available power sufficient to recharge the battery power of the UAV 310 such that the UAV is able to complete its flight mission (step 450). For example, in some aspects, the control circuit 210 of the central computing device 150 queries the central electronic database 160 to obtain GPS data indicating the location of the UAV 310 and all charging sources in relevant proximity to the UAV 310 and to select, from the charging sources 125 indicated in the central electronic database 160, a charging source 125 having both the available power sufficient to recharge battery power of the UAV 310 and a recharging device complementary to the UAV 310. In some aspects, based on an analysis of the GPS data indicating a current location of the UAV 310 and the selected charging source 125, the control circuit 210 of the central computing device 150 is configured to determine an in-air charging location 175 where the UAV 310 and the charging source 125 are to couple. The in-air charging location 175 may be directly along the flight route 120 of the UAV 310, or may require the UAV 310 to deviate from the flight route 120. It will be appreciated that, in some embodiments, the determination of a suitable charging source 125 and an in-air charging location 175 for the UAV 310 may be made by the control circuit 306 of the UAV 310 instead of the control circuit 210 of the central computing device 150.

In the embodiment depicted in FIG. 4, after the control circuit 210 of the central computing device 150 determines the charging source 125 for recharging and/or providing power to the UAV 310 as well as a suitable in-air charging location 175 for the coupling of the UAV 310 and the charging source 125, the method 400 further includes transmitting a guiding signal from the central computing device 150 to the UAV 310 over the network 115, with the guiding signal being configured to guide the UAV 310 toward the in-air charging location 175 (step 460). For example, the guiding signal transmitted by the central computing device 150 to the UAV 310 and/or the charging source 125 may include GPS coordinates of the in-air charging location 175 determined by the central computing device 150, as well as a flight route from the present location of the UAV 310 and/or charging source 125 to the in-air charging location 175.

With reference to FIG. 4, the method 400 further includes permitting (e.g., by way of generating and transmitting a guiding signal via the central computing device 150) the charging source 125 to couple to the UAV 310 to recharge the UAV 310 (step 470). As described above, such coupling of the UAV 310 and charging source 125 occurs at the in-air charging location 175. In some aspects, the coupling of the UAV 310 and charging source 125 at the in-air charging location 175 is via a connection 135, which may be a physical connection (i.e., one that results in physical contact) between the UAV 130 and the charging source 125, or a signal-based connection (i.e., one that does not require physical contact) between the UAV 130 the charging source 125. In certain embodiments, the method 400 may include permitting (e.g., by way of generating and transmitting a guiding signal via the central computing device 150) the UAV 310 and charging source 125 to travel, while coupled to each other (e.g., via the connection 135 at the in-air charging location 175), along at least a portion of the flight mission of the UAV 310 between the in-air charging location 175 and the delivery destination 180 in order to enable the UAV 310 to continue travelling along the flight mission route 120 while being continuously coupled to and recharged by the charging source 125. In some embodiments, the method 400 may include directly powering the UAV 310 via the charging source 125 without recharging the battery power of the UAV 310, thereby enabling the UAV 310 to continue its mission along the flight route 120 while being directly powered by the charging source 125. As described above, the guiding signal transmitted by the central computing device 150 to the UAV 310 and/or charging source 125 may include an indication of a time interval during which the charging source 125 is to be coupled to the UAV 310 to recharge the battery power of and/or directly power the UAV 310 during the travel of the UAV 310 along the at least a portion of the flight mission between the in-air charging location 175 and the delivery destination 180 and/or UAV deployment station 185.

The systems and methods described herein advantageously provide for the recharging of UAVs having a low battery while the UAVs are in-flight (e.g., on a flight mission from a deployment station to a delivery destination and vice versa, from one delivery destination to another delivery destination, etc.) The system monitors battery status of the UAVs in real time when the UAVs is performing a flight mission, detects when the battery power of a UAV is depleted such that a battery recharge is needed, determines which battery charging source to deploy to recharge the UAV while the UAV is airborne, and facilitates the coupling of the UAV and the charging source such that the battery of the UAV is recharged while the UAV continues to fly toward its intended destination. As such, the systems and methods described herein not only advantageously enable the UAVs to complete their current flight missions without delays associated with landing and recharging on the ground and/or swapping products between UAVs, but also advantageously prevent crashes of the UAVs associated with insufficient battery power.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

Docket No. 8842-140190-US 2267U502

What is claimed is:

1. A system for facilitating in-air recharging of unmanned aerial vehicles, the system comprising:
at least one unmanned aerial vehicle configured to perform a flight mission including taking off from a deployment station, transporting at least one product to at least one delivery destination, and returning to the deployment station;
a computing device including a processor-based control circuit and configured for communication with the at least one unmanned aerial vehicle over a network, the computing device being configured to:
receive, from the at least one unmanned aerial vehicle, at least one sensor input associated with a status of the at least one unmanned aerial vehicle during the flight mission;
determine, based on an analysis by the computing device of the at least one sensor input received from the at least one unmanned aerial vehicle, that the at least one unmanned aerial vehicle does not have sufficient battery power to complete the flight mission;
identify, after the determination by the computing device that the at least one unmanned aerial vehicle does not have sufficient battery power to complete the flight mission, a charging source having available power sufficient to recharge the battery power of the at least one unmanned aerial vehicle such that the at least one unmanned aerial vehicle is able to complete the flight mission; and
transmit a guiding signal from the computing device to the unmanned aerial vehicle over the network, the guiding signal being configured to guide the unmanned aerial vehicle toward an in-air charging location, where the charging source is permitted to couple to the unmanned aerial vehicle in order to recharge the battery power of the unmanned aerial vehicle;
wherein the charging source and the unmanned aerial vehicle remain coupled during travel of the unmanned aerial vehicle along at least a portion of the flight mission between the in-air charging location and the at least one delivery destination in order to enable the unmanned aerial vehicle to continue travelling along the flight mission while being coupled to and recharged by the charging source.

2. The system of claim 1, wherein the computing device is further configured to receive, from the at least one unmanned aerial vehicle, at least one sensor input comprising: battery status of the unmanned aerial vehicle, predicted flight range of the unmanned aerial vehicle until all battery power is depleted, mission status of the unmanned aerial vehicle, and global positioning system (GPS) coordinates of the unmanned aerial vehicle.

3. The system of claim 1, further comprising an electronic database in communication with the computing device and the at least one unmanned aerial vehicle over the network, the electronic database being configured to receive and store electronic data obtained by the at least one sensor of the at least one unmanned aerial vehicle, and to store electronic data indicating charging sources available to recharge the at least one unmanned aerial vehicle.

4. The system of claim 3, wherein the computing device is configured to obtain, from the electronic database and over the network, the electronic data obtained by the at least one sensor of the at least one unmanned aerial vehicle, and the electronic data indicating charging sources available to recharge the at least one unmanned aerial vehicle.

5. The system of claim 4, wherein the computing device is configured to analyze the electronic data obtained from the database and to select, from the charging sources indicated in the database, a charging source having both the available power sufficient to recharge battery power of the at least one unmanned aerial vehicle such that the at least one unmanned aerial vehicle is able to complete the flight mission and a recharging device complementary to the at least one unmanned aerial vehicle, and wherein the computing device is configured to determine a time interval during which the charging source is to be coupled to the unmanned aerial vehicle during the travel of the unmanned aerial vehicle along the at least a portion of the flight mission between the in-air-charging location and the at least one delivery destination.

6. The system of claim 1, herein the identified charging source comprises: a second unmanned aerial vehicle; an autonomous ground vehicle, a manned ground vehicle, a manned aerial vehicle, a mobile relay station, and power lines.

7. The system of claim 1, wherein the computing device is configured to determine global positioning system (GPS) coordinates of the in-air charging location, and to indicate, in the guiding signal, the global positioning system (GPS) coordinates of the determined in-air charging location.

8. The system of claim 1, wherein the computing device is further configured to transmit the guiding signal from the computing device to the identified charging source over the network, the guiding signal being configured to guide the charging source toward the in-air charging location, and wherein the guiding signal includes electronic data indicating how much power the identified charging source is to transfer to the at least one unmanned aerial vehicle.

9. The system of claim 1, wherein the charging source is configured to recharge the at least one unmanned aerial vehicle via at least one of: magnetic cable coupling, battery swap, RF induction, light induction on photocells, thermal transfer, laser induction, and physical coupling of the identified charging source to the unmanned aerial vehicle.

10. The system of claim 1, wherein the identified charging source is configured to directly power the at least one unmanned aerial vehicle without recharging the battery power of the unmanned aerial vehicle.

11. A method for facilitating in-air recharging of unmanned aerial vehicles, the method comprising:
providing at least one unmanned aerial vehicle configured to perform a flight mission including taking off from a deployment station, transporting at least one product to at least one delivery destination, and returning to the deployment station;
providing a computing device including a processor-based control circuit and configured for communication with the at least one unmanned aerial vehicle over a network;
receiving, at the computing device and from the at least one unmanned aerial vehicle, at least one sensor input associated with a status of the at least one unmanned aerial vehicle during the flight mission;
determining, by the computing device and based on an analysis by the computing device of the at least one sensor input received from the at least one unmanned aerial vehicle, that the at least one unmanned aerial vehicle does not have sufficient battery power to complete the flight mission;
identifying, by the computing device and after the determination by the computing device that the at least one unmanned aerial vehicle does not have sufficient battery power to complete the flight mission, a charging source having available power sufficient to recharge the battery power of the at least one unmanned aerial vehicle such that the at least one unmanned aerial vehicle is able to complete the flight mission; and
transmitting a guiding signal from the computing device to the unmanned aerial vehicle over the network, the guiding signal being configured to guide the unmanned aerial vehicle toward an in-air charging location;
permitting the charging source to couple to the unmanned aerial vehicle in order to recharge the battery power of the unmanned aerial vehicle;
after the charging source couples to the unmanned aerial vehicle, permitting travel of the unmanned aerial vehicle, while being coupled to the charging source, along at least a portion of the flight mission between the in-air charging location and the at least one delivery destination in order to enable the unmanned aerial vehicle to continue travelling along the flight mission while being coupled to and recharged by the charging source.

12. The method of claim 11, wherein the receiving step further comprises receiving, at the computing device and from the at least one unmanned aerial vehicle, at least one sensor input comprising: battery status of the unmanned aerial vehicle, predicted flight range of the unmanned aerial vehicle until all battery power is depleted, mission status of the unmanned aerial vehicle, and global positioning system (GPS) coordinates of the unmanned aerial vehicle.

13. The method of claim 11, further comprising an electronic database in communication with the computing device and the at least one unmanned aerial vehicle over the network, the electronic database being configured to receive and store electronic data obtained by the at least one sensor of the at least one unmanned aerial vehicle, and to store electronic data indicating charging sources available to recharge the at least one unmanned aerial vehicle.

14. The method of claim 13, wherein the identifying step further comprises obtaining from the electronic database, by the computing device and over the network, the electronic data obtained by the at least one sensor of the at least one unmanned aerial vehicle, and the electronic data indicating charging sources available to recharge the at least one unmanned aerial vehicle.

15. The method of claim 14, wherein the identifying step further comprises analyzing, by the computing device, the electronic data obtained from the database, and selecting, from the charging sources indicated in the database, a charging source having both the available power sufficient to recharge battery power of the at least one unmanned aerial vehicle such that the at least one unmanned aerial vehicle is able to complete the flight mission and a recharging device complementary to the at least one unmanned aerial vehicle, and further comprising determining, via the computing device, a time interval during which the charging source is to be coupled to the unmanned aerial vehicle during the travel of the unmanned aerial vehicle along the at least a portion of the flight mission between the in-air charging location and the at least one delivery destination.

16. The method of claim 11, wherein the identified charging source comprises: a second unmanned aerial vehicle; an autonomous ground vehicle, a manned ground vehicle, a manned aerial vehicle, a mobile relay station, and power lines.

17. The method of claim 11, wherein the transmitting step further comprises determining, by the computing device, global positioning system (GPS) coordinates of the in-air charging location, and indicating, in the guiding signal, the global positioning system (GPS) coordinates of the determined in-air charging location.

18. The method of claim 11, wherein the transmitting step transmitting the guiding signal from the computing device to the identified charging source over the network, the guiding signal being configured to guide the charging source toward the in-air charging location, and wherein the guiding signal includes electronic data indicating how much power the identified charging source is to transfer to the at least one unmanned aerial vehicle.

19. The method of claim 11, further comprising recharging the at least one unmanned aerial vehicle by the identified charging source via at least one of: magnetic cable coupling, battery swap, RF induction, light induction on photocells, thermal transfer, laser induction, and physical coupling of the identified charging source to the unmanned aerial vehicle.

20. The method of claim 11, further comprising directly powering the unmanned aerial vehicle via the identified charging source without recharging the battery power of the at least one unmanned aerial vehicle.
